(19) United States
(12) Patent Application Publication
(10) Pub. No.: US 2011/0251970 A1
(43) Pub. Date: Oct. 13, 2011

(54) Mobile social networking system and method

(76) Inventors: Derrick Oien, Cardiff by the Sea, CA (US); Shawn Conahan, San Diego, CA (US)

(21) Appl. No.: 11/789,695

(22) Filed: Apr. 24, 2007

(51) Int. Cl. G06F 15/16; G06Q 99/00

(52) U.S. Cl. 705/319; 709/204

(57) ABSTRACT

A mobile social networking system, method and platform are disclosed. A common set of functions is defined for a mobile social networking aggregator system. A set of components of one or more social networking websites is mapped to the common set of functions. The set of components mapped to the common set of functions is then normalized for being displayed in a common interface of the mobile social networking aggregator for each of a number of selected models of mobile devices.

### BACKGROUND

This disclosure relates generally to mobile communications, and more particularly to a platform and techniques for aggregating and integrating web-based social networking sites into a unified presentation with tools for branding and localization.

The mobile phone is being transformed into a Personal Media Device (PMD), enabling users to not only consume multimedia content, but to produce and share it as well. Activities on mobile phones such as Blogging, PodCasting and Vlogging are growing at explosive rates. Messaging is becoming a primary revenue source in the mobile services industry. Messaging includes the Short Message Service (SMS), Multimedia Messaging Service (MMS) and Instant Messaging (IM). Each of these activities are driven by platform companies that serve the network operators by aggregating traffic.

Each of these activities also supports a recent phenomenon known as social networking. Social networking websites, whether accessed through a desktop computer or via a mobile phone, are in aggregate the most popular form of communication on the World Wide Web, attracting over 70% of the U.S. population having interne access. Some consumers use a large number social networking services. At present there are over five hundred social networking sites, which number is growing at a rapid pace. Social networking and other community sites benefit from simplified technical integration and rapid time-to-market while maintaining branding and functional differentiation, all without having to bear the cost or effort of deployment.

In the traditional mobile media value chain, content is typically licensed, flows one-way, and provides no user interactivity. Financial margins to creators/providers erode as licensors and distribution channels exert leverage. Mobile-based applications have not been able yet to leverage the network effect of interconnected mobile devices. And discreet media payloads typically experience appropriation and confinement by a single specialized content source, which is an antithesis to millions of people with wireless content-gathering devices such as camera phones or video recorders, looking for an efficient way to communicate that content with the widest possible audience. Most carriers consolidate this communication through a platform company that serves as aggregator.

### SUMMARY

In general, this document discusses a mobile social networking system and method. In particular, this document discloses a social networking platform and applications that are mobility-relevant in both a closed and open environment, and which provides publishing tools integrated on PMDs.

The system enables social media networking and cross-carrier content superdistribution in the mobile space. A suite of mobile consumer products can be built, powered by a common platform. Accordingly, the system provides a mobile content distribution network on top of community sites that are enabled in the mobile space. The system is functionally in the middle of community-based communication: every text message, blog post, picture, ringtone, wallpaper, song, video or game passes from user to user or from producer to user through the platform.

In one aspect, a mobile social networking method is disclosed. The method includes mapping a set of components of one or more social networking websites to a common interface for each of a number of selected models of mobile devices. The method further includes integrating the set of components mapped to the common interface with existing messaging gateways associated with the selected models of mobile devices.

In another aspect, a mobile social networking aggregation method includes defining a common set of functions for a mobile social networking aggregator, and mapping a set of components of one or more social networking websites to the common set of functions. The method further includes normalizing the set of components mapped to the common set of functions for being displayed in a common interface of the mobile social networking aggregator for each of a number of selected models of mobile devices.

In another aspect, a mobile social networking system includes a gateway providing an interface to each of one or more social networking websites. The gateway is adapted to map a set of components of the one or more social networking websites to a common interface for each of a number of selected models of mobile devices. The system further includes a server configured to host the common interface and the set of components of the one or social networking websites. The server is further configured to integrate the set of components mapped to the common interface with existing billing infrastructures associated with one or more mobile service carrier networks used by the selected models of mobile devices.

In yet another aspect, a mobile social networking system includes a server adapted to integrate a set of aggregated social networking websites that have been functionally mapped to a common set of functions with existing billing and content management systems of one or more mobile service carriers, to provide a mobile aggregated social networking application to one or more mobile devices.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a mobile social networking platform.

FIG. 2 depicts a mobile media value chain of user-generated content for a mobile social networking platform.

FIG. 3 illustrates a mapping of a partner site content and profiles to a standardized core interface.

FIG. 4 depicts a number of functional layers of a mobile social networking platform to aggregate partners and users.

Like reference symbols in the various drawings indicate like elements.

### DETAILED DESCRIPTION

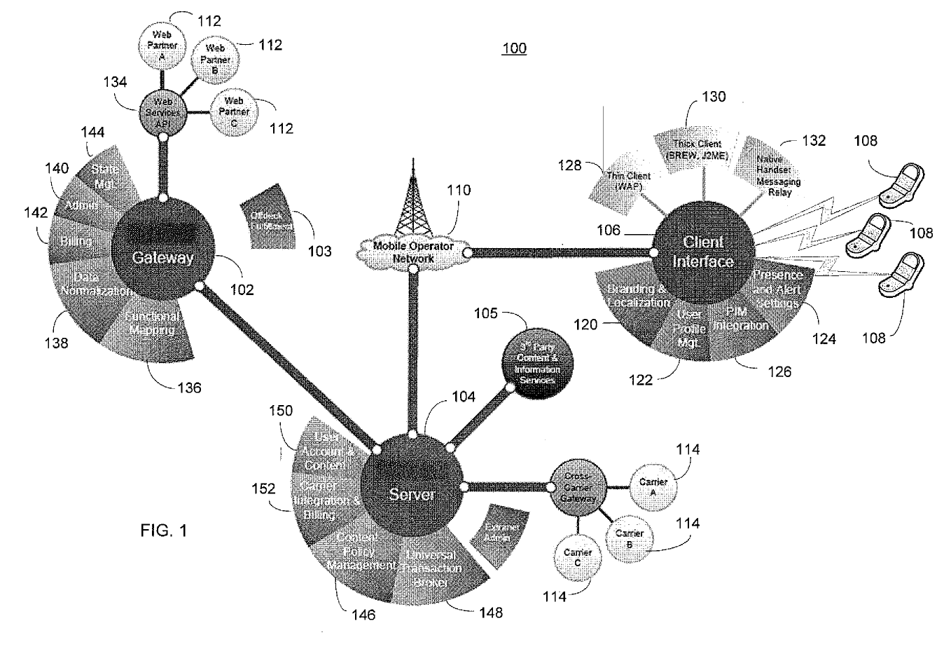

This document describes a mobile social networking (MSN) platform. As illustrated in FIG. 1, the MSN platform 100 includes a gateway 102 a server 104, and client interface 106, connected and adapted to “mobilize” one or more social networking sites from web-based social networking site (SNS) partners 112 for a number of mobile clients (MCs) 108 connected to a mobile operator network 110.

Three main parties to the MSN platform 100 include carriers 114, SNS partners 112, and carrier subscribers and their mobile devices 108. The MSN platform 100 enables carriers 114 to aggregate existing or new SNS partners 112 and make them available to carrier subscribers 114 in a monetized, predictable form. Monetization models supported by the MSN platform 100 include premium messaging, subscription, advertising and content merchandising.

At the highest level, the MSN platform 100 is a hosted application service provider (ASP) infrastructure managing communications between carrier systems 114, subscriber devices and SNS partners 112. Carriers can use the MSN platform to lower the cost of making SNS partners 112 available to subscribers 108 and as an avenue to increase data exchange. Carriers can still retain control over service marketing, defining the monetization model and choosing which SNS partners 112 to offer to subscribers 108.

Functions such as data integration, media handling, content policy management and transaction processing are centralized by the MSN platform 100, making deployment of a complete social networking offering to consumers quick and easy for network operators. Aggregating all social networking providers via a centralized MSN platform 100 enables network operators to capitalize on the full opportunity that the social networking trend represents, while enabling rapid deployment of future providers.

Accordingly, the MSM platform 100 provides mobile subscribers with in-demand social networking brands through a carrier-centric environment that emphasizes affordability, addressability and usability, and enables mobile social networking, blogging, community and media sharing. By aggregating social networking functions for a unified client interface 106, the gateway 102 enables network operators to bring social networking to mobile subscribers in a compelling consumer offering that maintains partner branding and functionality while providing essential mobile-centric services, enhancements and controls to carriers.

Rather than a service provider selecting what is preferable to a consumer, the MSN platform 100 enables consumer choices. Thus, all social networking services, and their content, are aggregated and integrated into a common interface for offering to mobile subscribers. The MSN platform 100 can intelligently and selectively receive existing content and features, and transform them to a mobile user interface (UI) via the client interface 106. The MSN platform 100 also integrates with a variety of mobile media providers to fulfill media and information in the context of a partner site. The result is a carrier-centric mobile version of the partner site, rather than a 1:1 mapping of functionality, and a network of users for which content distribution rights are obtained and managed.

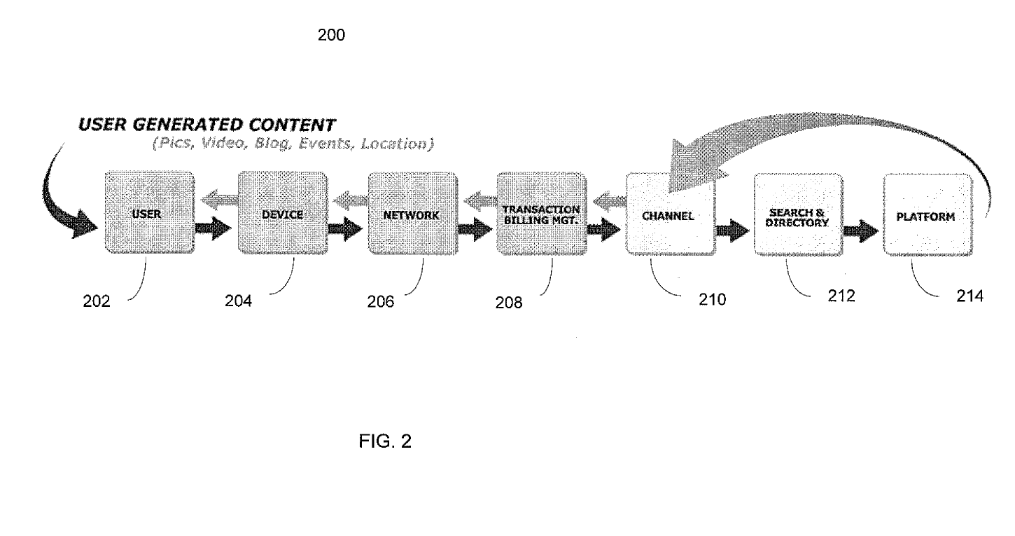

Referring briefly to FIG. 2, a new mobile media value chain 200 enabled by the MSN platform 100 is shown, comprising largely user-generated content without licensing issues. The MSN platform 100 enables an interactive flow of user 202 generated content (text, photos, videos, etc.) from device 204 to network 206 and transaction billing management 208, where value increases with usage, i.e. sharing among users 202. Less margin erosion, plus secondary distribution opportunity. The users 202 are the network, and the value is in the community of users 202. Content can be provided to specific channels 210 that are defined by search and directory systems 212 associated with a particular social networking platform 214.

The MSN platform 100 enables every user to have their own mobile “space,” strictly defined by a portion of memory on the server 104, that serves as their media and communication hub, whether it is an existing web-based account or a newly created account. Complex social networking and blogging sites are mapped to a functional server component of the server 104, which then presents services to the user in the form of native messaging integration using existing SMS, MMS and IM gateways and billing infrastructure, and as a simple and elegant client user interface.

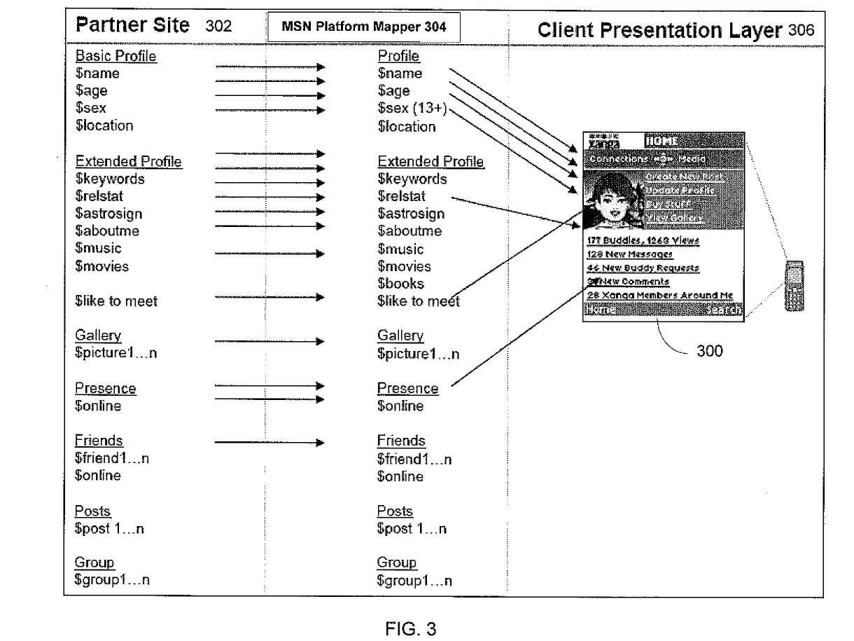

With reference also to FIG. 3, a core interface 300 can be fully customizable and able to be branded, which gives partner sites the ability to focus the user on the content and communication, rather than on learning a complicated UI. The user experiences a similar core interface 300 across multiple social networking sites, starting with a main menu of community choices. Once the UI construct is familiar, there is no learning curve for users who use multiple community applications. Partner site 302 content and profile data is mapped by the MSN platform mapper 304 to a unified core interface 300 in a client presentation layer 306.

New communities can be added from scratch. For example, whenever a new album or movie is released, a community built around that brand containing related promotional content can be deployed as a marketing tool, enabling consumers to use their universal login to participate in the sharing of information. The container application is distributed once and updated over the air. A common SNS menu can be generated from the server 104, so no additional technical integration is required from carriers 114. Thus, the MSN platform 100 is a complete end-to-end solution to enable social networking and community sites in the mobile space. A carrier-centric approach builds on the network operator data business models, ensuring proper controls in a cross-carrier deployment.

The client interface 106 delivers branded user interfaces that are fully integrated with online community sites to encourage adoption. Components and features of the client interface 106 include a branding and localization module 120, and universal client, OTA client upgrades and service additions via user profile management module 122. The client interface 106 also includes alert and messaging preference settings and presence status indicator provided by a presence and alert settings module 124, and a personal information management (PIM) module 126, discussed further below. A thick client 128 support includes J2ME, BREW and Symbian, while a thin client 130 and native handset messaging relay 132 ensures message integration and broad addressability across all device types of mobile clients 108.

The client interface 106 controls the presentation of social networking applications to end users, while core functionality is processed by the server 104 and then optimized for the client UI. Users have the option of interfacing with their favorite sites in a variety of ways which all work together seamlessly to present a unified experience to the entire community. A user may download a thick client from the carrier's deck or from the partner site, providing a robust interactive media experience. A user without a thick client may receive a message (native SMS) from a web-based user, then click through to a WAP version of that user's personal page. The native handset messaging relay 132 server facilitates cross-carrier and web-to-mobile messaging without requiring any download.

The gateway 102 integrates seamlessly with web-based social networking and community sites 112. Deep integration and functional mapping ensure feature richness while optimizing data for the mobile environment. Offdeck fulfillment capabilities 103 enable web-based community sites to distribute their mobile product directly from their sites.

The gateway 102 is the point of integration with SNSs and other community partner sites 112 via web services API 134. As the link between web-based partners 112 and the server 104, the gateway 102 extends the web-based social networking experience to the mobile environment and actively translates the functionality of the SNSs between the web and mobile application. Providing subscribers with simple mobile access to their favorite blogging, social networking and community sites enables them to stay engaged by allowing them to create posts and pictures, browse content and message with friends.

The gateway 102 maps web-based functionality to the mobile carrier world, delivering seamless integration while translating content and services to suit the capabilities of the individual carrier network. The gateway 102 includes a functional mapping module 136 to provide a link between partner site 112 functionality and the carrier-specific technical environment while maintaining the branding, nomenclature and presentation of the partner site 112. A data normalization module 138 converts all content on the fly and normalizes it across a handset support matrix which ensures efficient presentation and an optimized user experience. An administration module 140 allows the network operator to retain control over their network resources by using a single point of integration to aggregate social networking sites, enabling oversight and management of IP and messaging volume.

Deep partner integration also means the ability to provision the partner's mobile offering directly from their site utilizing the integrated carrier billing infrastructure 142 and state management 144 for fulfillment. The billing infrastructure can be combined with the MSN platform's universal client to deliver a category-wide common interface to enable a single sign-on deployment, and significantly shorten the subscriber learning curve for all category partners. By consolidating billing, functional mapping and data through normalization, social networking sites can gain rapid entry into the mobile space and carriers have a template to deploy multiple partners on their networks.

The server 104 is configured to enable mobile operators to capitalize on the growing trend in social networking while preserving carrier business rules. The server 104 provides centralized technical integration and administration which enable universal content policies and transaction handling. Via the server 104, interconnection with other operators is achieved transparently, preserving branding and a specific user environment.

The server 104 optimizes the user experience while managing several key issues for network operators. The server 104 includes a content policy management module 146 providing filtering and content monitoring tools that enables all social networking partners through a single platform, so that network operators can employ a category-wide content policy across all partners. The server 104 further includes a universal transaction broker 148 that brokers among a number of communication protocols used by carriers and networks to ensure broad support across all handset classes while conserving bandwidth. This gives the carrier visibility into and control over the entire category, plus the tools to meter bandwidth.

A master user account module 150 implementing a platform for partner functionality, so that carriers can integrate other services through a single sign-on, enabling content sales, application cross-selling and other promotional efforts. A carrier integration and billing module 152 implements a platform for integrated carrier billing services.

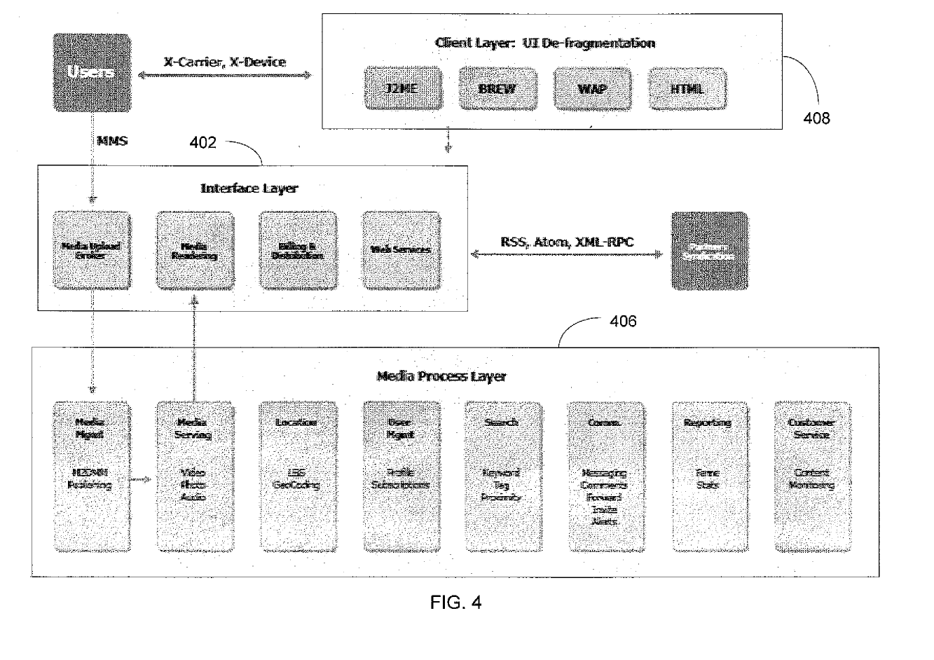

With reference also to FIG. 4, the MSN platform 100 integrates with existing carrier messaging, billing and data communication infrastructure, across an interface layer 402. This integration is customized for each carrier 114 using standard processes determined by the carrier 114 for access to these systems and gateways. The MSN platform 100 also connects to SNS partners 112, such as existing web-based social networking sites, white-label and carrier-branded communities. The MSN platform 100 can also integrate with existing third-party mobile communities, i.e. third party content and information services 105, using APIs.

SNS partners 112 communicate with subscribers 108 through a separate SNS Partner Integration Module. Communication through the SNS Partner Integration Module can use either the MSN platform's APIs or a SNS partner's 112 own API set. The MSN platform 100 essentially brokers information to and from the SNS partners 112 to subscribers 108 to optimize the user experience while maintaining carrier technical standards. The MSN platform 100 communicates to subscribers 108 over the carrier's 114 data and messaging channels (mobile operator network 110). Additionally, elements of the MSN platform 100 are accessed on the subscriber's devices through client applications or via a third party application using the MSN platform 100 client APIs. Examples of available client platforms are WAP, xHTML, J2ME, Windows Mobile and BREW. Client applications provide the benefit of delivering client software with a unified look, feel and functionality across multiple device platforms, minimizing the learning curve for subscribers 108. The MSN platform 100 also includes a toolkit (not shown), a codeset that enables optional access to media and network management features, described in further detail below.

In one preferred implementation, the MSN platform 100 is physically comprised of a server, a database, and related network elements installed in a data center. The network elements are configured to provide reliable, fully-redundant services. Depending on the geographical location and performance requirements related to providing services to a specific set of subscribers, associated physical instances of the MSN platform 100 can be established. Carrier interaction is dependent on the components of the MSN platform 100 that are responsible for billing, messaging and customer service interaction with a carrier 114.

SNS partner 112 interaction relies on components that manage access to SNS partners 112 and administer content destined for subscribers 108. A device mapping matrix ensures that media display, application provisioning and transaction management are managed as appropriate to a given Carrier Subscriber's device. The MSN platform 100 is designed to provide Carriers with the ability to deploy multiple Social Networking Partners through a one-time integration to the gateway 102 and server 104, essentially aggregating through a single platform the technical integration that would otherwise be required for each partner. The connections established between the MSN platform 100 and the carriers 114 include messaging, billing, and user requests/responses.

The MSN platform 100 manages three types of messages using the native MMS and SMS capabilities of subscriber services. These message types are:

1) Content Upload Messages. These are messages used by the subscriber to upload graphic or other multimedia content and transit the Carrier MMS-C as a Mobile Originated (MO) message. These are 1-way messages. An example is a subscriber uploading a picture to their blog via the SNG.

2) Anonymous Proxy Messaging. These are generated by intra-community messaging, group posting, private messaging and similar communication. A sample message flow is User A sending the message “How are you?” to User B on a particular community. The message arrives to User B as an SMS and only exposes User A′s community name, and not their phone number. User B can reply “I′m Great!” to the received SMS, which is then sent as an MO-SMS through the Carrier SMTP to the MSN platform 100. The server 104 and/or gateway 102 reads the conversation tracking number (conversation tag) and anonymously forwards the message back to User A as a MT-SMS through the carrier SMTP.

3) Alerts. These are Mobile Terminated (MT) alerts generated by either SNS partners 112 or initiated by community user actions that the MSN platform 100 forwards to the subscriber 108. They are one-way and informational in nature. An example is User A receiving an alert from one of their SNS saying that User B has added a comment to User A′s profile. Although these messages transit a Carrier's SMTP, SMS-C and MMS-C messaging gateways, currently only integration with the carrier's SMTP gateway is required. All MMS-C and SMS-C messages are MO and supported entirely by existing carrier messaging.

In a few cases, such as a non-standards based subscriber device, a modified carrier integration module can be developed that differs from the standard mechanism described in this section. Connection to the carrier SMTP is preferably established in accordance with carrier policies regarding message source white-listing, origin filtering and other requirements. White-listing is required in the event that a carrier applies a quota or limit on the number of messages that can be passed to the carrier SMTP from a single source in a given period.

The gateway 102 and server 104 are configurable to ensure that messaging traffic does not exceed the capabilities of the carrier SMTP infrastructure. Receipt of messages from the MSN platform 100 can be enabled or disabled by the subscriber 108 in the client settings. Messages are only received by subscribers in relation to use of SNS services. To ensure that subscribers are in full control of communication preferences, the MSN platform 100 also enables subscribers 108 to selectively block other users and to enable or disable message types.

The MSN platform 100 connects to the carrier's existing billing system according to the carrier's desired connectivity method and protocol, usually via existing API or third party, though custom integration may be required for certain monetization options. (e.g., bill back on user-generated media, etc.). A one-time integration for billing connectivity enables an infinite number of SNS partners through the MSN platform 100. The MSN platform 100 supports multiple security configurations for billing connectivity, including Virtual Private Network (VPN), IP-source security, token-exchange, standards-based encryption and basic authentication. Subscribers can use the services through thin or thick applications on their mobile phone or similar Carrier device. Connectivity between the MSN platform 100 and the subscriber's mobile devices is achieved using the HTTP protocol over the standard carrier data channel, whether the subscriber is using a J2ME, BREW, WAP/xHTML, Windows Mobile, Flash or other client base.

Depending on the business and service configuration desired by a carrier, white-list access to the subscriber device data channel and/or permission-based access may be required. Although the MSN platform's public servers are the default point of interaction between carrier infrastructure and the gateway 102, higher security options are available if desired by the carrier.

The MSN platform 100 offers comprehensive support of most functionality through APIs. These APIs are used to deploy new SNS Providers and to enable creation of services by parties external to the carrier. There are two aspects to the APIs: SNG Partner APIs, and SNG Client APIs. SNG Partner APIs are used for sending requests to SNS partners 112 and for SNS partners 112 to send requests to the MSN platform 100. The SNG Client APIs, discussed further below, are APIs that client applications on subscriber devices use to communicate and request services from the MSN platform 100.

The APIs are available in a variety of protocol base options including SOAP, REST and XML-RPC. Access to the APIs is enabled using a partner API key. In the event a carrier elects to deploy the toolkit or to use the APIs to support a limited or public-release developer program, additional one-time integration and/or ongoing technical coordination will be required.

Internationalization is a concern for carriers that serve multiple language groups in a single region or serve multiple countries with different language requirements. The MSN platform 100 is fully internationalized and supports all major world languages. In cases where language filtering of content is desirable for a given carrier market, the MSN platform is configured to ensure that requests from the client retrieve content from the SNS partner 112 in the relevant language. In addition to supporting internationalization and localization, the gateway 102 provides the capability to segment carrier subscribers into linguistic, geographical and country-based groupings as required.

The MSN platform 100 supports two basic methods for subscribers 108 to access SNS partners 112: Access via a MSN platform 100 container client, and access via a third-party client using the gateway 102 APIs. For access with the container client, the gateway 102 enables multiple SNS partners 112 by translating protocol and representing functionality to end users with a compelling UI in unified client applications. These clients are referred to as container clients because they encompass the range of functionality present in SNS services and can be “filled” with branding and functionality of a specific SNS service.

While the container client always belongs to a single subscriber on a single carrier, it can support multiple SNS partners 112. This is achieved by a logical and functional separation of the program code from the presentation layer branding and presentation. For example, the gateway container client code would download into the program memory on a J2ME subscriber device as is the case with any J2ME application. However, on the first load, the logo, text and other assets for the desired SNS partner 112 are retrieved and stored in the device's RMS memory.

The case of WAP/xHTML is even simpler, with a subscriber having the capability to access WAP/xHTML pages dynamically based on which SNS partner 112 they wish to use. The container client displays carrier branding and is always unique to a single carrier. The container client itself has two varieties: multi-SNS container client, and single SNS container client. The multi-SNS container client is designed to give subscribers the ability to select from and switch between multiple SNS partners 112. The primary differentiator for this client is the presence of a lobby as the first screen presented to a subscriber. The lobby presents the various SNS partners 112 available through a carrier to subscribers and allows a choice of SNS partners 112. A subscriber can return to the lobby at any time and select a different SNS partner 112 to use. This Subscriber behavior is consistent with the multiple allegiances and shifting preferences of the target SNS demographic.

The Single SNS container client is functionally identical, but lacks lobby functionality. Thus, it is tailored for use in situations where the carrier wishes to provide access to a single SNS partner 112 or as a transition to the multi-SNS container. A subscriber can access the gateway 102 through various clients, depending on their device's characteristics. As most carriers support a combination of both thin (WAP/xHTML/cHTML) and thick (J2ME, BREW, Microsoft, Symbian, etc.) clients across the installed base of subscriber devices, the gateway 102 can provide a range of client options that maintain consistent branding, service experience and pricing. For example, a subscriber may wish to access SNS partners 112 via a combination of J2ME and xHTML. Another subscriber may have a Windows Mobile phone and require either a Windows mobile client or access via Pocket Internet Explorer.

Container clients can be provisioned using a carrier's existing process or pre-provisioned as an installed client on subscriber devices. All clients are available for branding and localization. Third-party client using the gateway APIs, while provides a robust subscriber experience, there are cases in which a carrier will want to leverage internally or externally developed clients and applications while maintaining the integration, deployment and financial benefits of the gateway 102. The APIs also support access to features like the media toolkit (discussed below) and SNS features for applications such as games that are not social networking focused, but wish to include social functionality.

The toolkit is provided by a media process layer 406, and enables access to media and network management features related to social networking. The toolkit preferably takes the form of code that is integrated into clients on the subscriber device and/or policies that are applied through the MSN platform 100. toolkit elements are adopted in line with carrier technical, business and financial goals.

There are a number of toolkit options. A media toolkit deals with access to the media creation, viewing and storage capabilities of subscriber devices. Examples are the device camera, video recorder or audio recorder. Depending on the carrier's infrastructure and device inventory, enabling the media toolkit may include: ensuring that container clients are compatible with the methods the carrier devices use to enable access to the media creation and storage (ex. camera and gallery) on the subscriber device; and integration with a carrier's policy-based access to media creation and storage on the subscriber device. In the event that a carrier has an existing media gallery-type service, the media toolkit may ‘proxy’ into the current service in order to expand access to media stored to the SNS partner's 112 services.

Contact information is a key enabler for users of SNSs to manage and expand their social network. A contacts toolkit provides permission-based features that enable Subscribers to invite friends into an SNS community and facilitates transfer of friends into the SNS partner(s) a subscriber chooses to join. The primary initial data source for the contacts toolkit is the personal information manager (PIM) on the subscriber device.

In one example, a subscriber decides to use an SNS through the MSN platform 100 for the first time and accesses the container client. The client asks the subscriber if he or she would like to have the contacts in his/her PIM accessible through the container client. If the subscriber agrees, the client establishes contact with the PIM. The subscriber may invite contacts in his/her PIM to join a SNS partner 112, may see which of his/her contacts are already in a SNS partner community and/or update contacts on his/her activities in the SNS Partner communities. Technically, the contacts toolkit is comprised of code integrated into the container client and optimized for each carrier device platform.

Just as with the media toolkit, all use of information is in control of the subscriber and no action is taken with contact data without explicit authorization in accordance with guidelines agreed to by the carrier and administered by the MSN platform 100. As with the media toolkit, the contacts toolkit may ‘proxy’ an existing carrier contacts back-up or administration service.

Lastly, a location based services (LBS) toolkit enables permission-based features dependent on location, geography or proximity. For example, a subscriber uses the media creation features of a SNG Client to make a post about a club they're currently in. Based on the location permission preferences of the subscriber allowing access to the Carrier LBS infrastructure, the subscriber device retrieves either a numeric geographic reference (ex. lat, long) or a fully resolved location name, such as ‘The Cool Club’. In either case, the SNG geo-tags the post with the location ‘Cool Club’. The subscriber approves the post and it is added to the subscriber's shared postings and is indexed under the Cool Club's location page. Technically, the LBS toolkit is comprised of code integrated into the container client and optimized for each carrier device platform. The LBS toolkit also interacts with subscriber preferences and may interact with SNS Partner location databases. By necessity, the LBS toolkit requires permission from the subscriber to access and/or share location information and also coordination with the carrier's LBS infrastructure and data access control mechanism.

Rather than integrate with dozens of social networking partners and provision as many applications, the MSN platform 100 enables the carrier to integrate with their network resources once and then add additional partners over time within the same technical construct. This centralizes billing, gallery access, content policy management, content transcoding, state management, subscriber account management and customer service, reducing implementation risk and improving the quality of the user experience.

As mentioned previously, the MSN platform is architected to sit completely outside of the carrier network: to provide end users a client layer 408 with full thick-client functionality requires only SMTP access, whitelisting and a form of billing, which is determinable by the carrier. There are several integration options available depending on carrier business models and technical constraints. The following is a list of integration touchpoints and the options associated with each.

Carrier-direct billing: Uses existing proprietary billing infrastructure, generally requiring no integration to the MSN platform 100. The carrier provides proprietary or third-party billing APIs.

P-SMS billing: The MSN platform 100 enables carriers to bill for SNS subscription access through the P-SMS gateway. A subscriber downloads a free universal client, that aggregates all the SNS partners then selects a subscription period (popular carrier choices are 24-hour access and monthly) through the app. This notifies the server to enable time-limited or recurring access to a particular SNS community. The server sends a receipt to the subscriber through the P-SMS gateway, which is the billing mechanism for access. Requirements include carrier documentation, P-SMS gateway vendor integration, quality assurance, and testing.

Custom integration: The carrier's billing system is directly accessed by the Anthem platform. The carrier's billing API communicates to the platform to trigger charges for usage of the application on a time-specific or data-specific basis. Requirements: Technical requirements and documentation to API, access/permission to gateway, customer service requirements and possibly resolution system integration.

Gallery integration direct device gallery integration: The application accesses the device's image files and directly extracts them from the device and sends them to the mobile gallery within the application. This requires a supported device list from the carrier, access to the JSR (or BREW API, etc.) to implement the feature, a client gallery integration, carrier API documentation, testing and QA.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, of portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A mobile social networking method, comprising:
mapping a set of components of one or more social networking websites to a common interface for each of a number of selected models of mobile devices; and
integrating the set of components mapped to the common interface with existing messaging gateways associated with the selected models of mobile devices.

2. A mobile social networking method in accordance with claim 1, further comprising transforming web-based content from the one or more social networking websites to a mobile-relevant content format associated with the selected models of mobile devices.

3. A mobile social networking method in accordance with claim 1, wherein integrating the set of components mapped to the common interface with existing messaging gateways further includes brokering communication protocols of the existing messaging gateways between the common interface and one or more mobile service carrier networks used by the selected models of mobile devices.

4. A mobile social networking method in accordance with claim 1, further comprising integrating the set of components mapped to the common interface with existing billing infrastructures associated with one or more mobile service carrier networks used by the selected models of mobile devices.

5. A mobile social networking method in accordance with claim 1, further comprising customizing the common interface with branding associated the one or more social networking websites and/or one or more mobile service carrier networks used by the selected models of mobile devices.

6. A mobile social networking method in accordance with claim 1, wherein the common interface is navigable in multiple directions according to a keypad of the selected models of mobile devices.

7. A mobile social networking method in accordance with claim 1, further comprising generating an access link for each of the one or more social networking websites on a display of the common interface.

8. A mobile social networking aggregation method, comprising:
defining a common set of functions for a mobile social networking aggregator;
mapping a set of components of one or more social networking websites to the common set of functions; and
normalizing the set of components mapped to the common set of functions for being displayed in a common interface of the mobile social networking aggregator for each of a number of selected models of mobile devices.

9. A mobile social networking method in accordance with claim 8, further comprising integrating the set of components mapped to the common interface with existing messaging gateways associated with the selected models of mobile devices.

10. A mobile social networking aggregation method in accordance with claim 9, wherein integrating the set of components mapped to the common interface with existing messaging gateways further includes brokering communication protocols of the existing messaging gateways between the common interface and one or more mobile service carrier networks used by the selected models of mobile devices.

11. A mobile social networking aggregation method in accordance with claim 8, further comprising transforming web-based content from the one or more social networking websites to a mobile-relevant content format associated with the selected models of mobile devices.

12. A mobile social networking aggregation method in accordance with claim 9, further comprising integrating the set of components mapped to the common interface with existing billing infrastructures associated with the selected models of mobile devices and one or more mobile service carrier networks used by the selected models of mobile devices.

13. A mobile social networking aggregation method in accordance with claim 9, further comprising customizing the common interface with branding associated the one or more social networking websites and/or one or more mobile service carrier networks used by the selected models of mobile devices.

14. A mobile social networking aggregation method in accordance with claim 8, wherein the common set of functions is optimized for the selected models of mobile devices.

15. A mobile social networking system, comprising:
a gateway providing an interface to each of one or more social networking websites, and adapted to map a set of components of the one or more social networking websites to a common interface for each of a number of selected models of mobile devices; and
a server configured to host the common interface and the set of components of the one or social networking websites, and to integrate the set of components mapped to the common interface with existing billing infrastructures associated with one or more mobile service carrier networks used by the selected models of mobile devices.

16. A mobile social networking system in accordance with claim 15, wherein the gateway is further configured to integrate the set of components mapped to the common interface with existing messaging gateways associated with the selected models of mobile devices.

17. A mobile social networking system in accordance with claim 15, further comprising a client interface application adapted for being hosted on the selected models of mobile devices to display the common interface.

18. A mobile social networking system in accordance with claim 17, wherein the client interface application is further configured to integrate branding and location-based services to the common interface.

19. A mobile social networking system in accordance with claim 17, wherein the client interface application is further configured to execute user profile management of users associated with the mobile devices.

20. A mobile social networking system comprising a server adapted to integrate a set of aggregated social networking websites that have been functionally mapped to a common set of functions with existing billing and content management systems of one or more mobile service carriers, to provide a mobile aggregated social networking application to one or more mobile devices.
